(19) United States
(12) Patent Application Publication
(10) Pub. No.: US 2009/0088909 A1
(43) Pub. Date: Apr. 2, 2009

(54) Batch processing apparatus for processing work pieces

(75) Inventor: Naoki Yokoi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY, INC., Tokyo (JP)

(21) Appl. No.: 12/232,886

(22) Filed: Sep. 25, 2008

(30) Foreign Application Priority Data
Sep. 27, 2007 (JP) 2007-250935

(51) Int. Cl. G05D 23/00; B08B 3/12

(52) U.S. Cl. 700/300; 134/57 R

(57) ABSTRACT

In a batch cleaning apparatus having a one-bath-type cleaning tank, control is performed such that an average temperature of cleaning liquid in the cleaning tank is uniform among different batches. The one-bath-type cleaning tank has a megasonic oscillator for cleaning objects to be cleaned. A control computer controls the supply temperature of pure water supplied from a pure water heating device to dilute chemical solution so that variation in solution temperature occurring during application of megasonic waves is compensated. The objects to be cleaned are cleaned with an average solution temperature kept at a fixed level for all the batches, while maintaining a high cleaning efficiency.

This application is based upon and claims the benefit of priority from Japanese patent application No. 2007-250935, filed on Sep. 27, 2008, the disclosure of which is incorporated herein in its entirety by reference.

### BACKGROUND OF THE INVENTION

1. Field of the Invention

The present invention relates to a batch processing apparatus and, more particularly, to a batch processing apparatus suitable for use as a cleaning apparatus for cleaning work pieces such as semiconductor wafers.

2. Description of the Related Art

Along with recent technical development, a need has arisen to remove a minute amount of contaminants from semiconductor substrate (wafer) surfaces in a manufacturing process of semiconductor devices. Conventional batch-type cleaning apparatuses for cleaning a plurality of semiconductor substrates at the same time principally employ a circulation tank for circulating and reusing a chemical solution. This type of cleaning tank has piping for circulating the chemical solution, which is provided with a heater, a temperature gauge, and other equipment for controlling temperature of the chemical solution. Such conventional cleaning apparatuses have problems of difficulty in cleaning wafers at an optimum temperature due to variation in washing liquid temperature during loading of the wafers or supply of the washing liquid.

Japanese Laid-Open Patent Publication No. H05-304130 (hereafter referred to as the patent document) describes a method of controlling solution temperature for keeping washing liquid at a fixed temperature by heating the same. According to the patent document, the temperature drop occurring when wafers or supplementary washing liquid is loaded during cleaning is preliminarily measured. Before loading wafers or supplementary washing liquid for the next cleaning process, a temperature set by a liquid temperature controller is changed to compensate the measured temperature drop. Specifically, the temperature is set slightly higher than normal before loading the wafers or supplementary washing liquid. This makes it possible to clean the wafers at a proper temperature.

The wafer cleaning apparatus described above is able to keep the chemical solution temperature at a fixed level and to perform efficient cleaning. However, after cleaning many semiconductor substrates in the wafer cleaning tank, there arises a problem that the contaminants removed from the semiconductor substrates and accumulated in the chemical solution in the cleaning tank reattach to other semiconductor substrates.

In order to prevent the reattachment of contaminants in a cleaning tank, one-bath-type cleaning tanks have come into use in which a chemical solution is disposed after every batch. The one-bath-type cleaning tanks are not provided with a mechanism for controlling temperature of the chemical solution in the cleaning tanks since the chemical solution is disposed after use.

Therefore, after a chemical solution having a certain temperature is supplied, the temperature of the chemical solution is gradually decreased by natural heat dissipation.

### SUMMARY

Using such conventional one-bath-type cleaning tanks, it is difficult to clean substrates at an optimum temperature. However, there exists a demand for achieving substrate cleaning at an optimum temperature in the one-bath-type cleaning tanks as well by performing temperature control.

Some of the one-bath-type cleaning tanks are provided with a function of radiating megasonic (supersonic) waves for efficient removal of contaminants from the semiconductor substrate surfaces. In the case of such a cleaning tank, a chemical solution in the cleaning tank receives thermal energy from the radiated megasonic waves. Therefore, the chemical solution temperature in the cleaning tank is affected by the intensity of the radiated megasonic waves or the radiation period. When manufacturing recent semiconductor devices with extremely fine patterns with the use of such a one-bath-type cleaning tank, there arises a problem of instability in the cleaning performance and efficiency caused by instability in the temperature of chemical solution in the cleaning tank. The problem of the instability of the chemical solution temperature occurs not only in the wafer cleaning apparatuses but also in etching devices in which supersonic waves are applied to a semiconductor substrate in a process solution to remove a natural oxide film, for example, or in cleaning apparatuses for etching away an underlying film during the cleaning.

In view of the problems described above, the present invention provides a batch processing apparatus capable of achieving stable processing performance and processing efficiency in batch processing in which megasonic (supersonic) waves are applied to objects to be processed within a process solution.

The present invention provides a batch processing apparatus having a batch tank for immersing objects to be batch-processed in a process solution and batch-processing them in the process solution with the use of supersonic waves. The batch processing apparatus of the invention has a solution temperature predicting unit for predicting variation in temperature of the process solution in the batch tank, at least based on variation in temperature of the process solution in the batch tank predicted by application of supersonic waves to the objects to be batch-processed.

In one aspect of the embodiment, there is provided a batch processing apparatus for performing batch processing by immersing objects to be processed in a process solution. The batch processing apparatus comprises: a batch tank; a supply unit for supplying the process solution to the batch tank; a supersonic waves generating source for applying supersonic waves to the objects to be processed in the batch tank; and a control unit for controlling supply temperature of the process solution based on data representing at least relationship between output of applied supersonic waves and variation in temperature of the process solution.

In accordance with another aspect of the embodiment, there is provided a batch processing apparatus which comprises: a supply unit for supplying the process solution to the batch tank; a data storage unit for storing data relating to time variation in process solution temperature based on actually measured temperature values for each set of parameters including at least process solution supply temperature, number of semiconductor work pieces, and intensity of applied supersonic waves; and a control unit which, in response to designation of processing conditions including number of semiconductor work pieces, intensity of applied supersonic waves, temperature of a supplied chemical solution, and processing time, predicts an average solution temperature during processing under the designated conditions by supplementing the designated processing conditions with the data stored in the data storage unit, determines a supply temperature of the process solution based on the predicted average solution temperature, and controls the supply unit.

In a still another aspect of the embodiment, there is provided a solution temperature control method in a batch processing apparatus for processing semiconductor work pieces by applying supersonic waves to the semiconductor work pieces in a process solution in a batch tank. The method comprises: storing data relating to time variation in process solution temperature based on actually measured temperature values for each set of parameters including at least process solution supply temperature, number of semiconductor work pieces, and intensity of applied supersonic waves; counting a number of the semiconductor work pieces; designating processing conditions including number of semiconductor work pieces, intensity of applied supersonic waves, temperature of supplied chemical solution, and processing time. The method further comprises: predicting an average solution temperature during processing under the designated processing conditions by supplementing the designated processing conditions with the stored data, thereby providing a supply temperature of the process solution based on the predicted average solution temperature; and supplying the process solution at the supply temperature to the batch tank.

The batch processing apparatus or the solution temperature control method for use in a batch processing apparatus predicts variation in temperature of the process solution based on predicted increase of the solution temperature caused by application of supersonic waves. This makes it possible to exactly keep the solution temperature at a predetermined value.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram of a one-bath-type semiconductor substrate cleaning apparatus as a batch processing apparatus according to a first embodiment of the present invention;

FIG. 2 is a chart showing variation in solution temperature observed when loading wafers into the wafer cleaning apparatus shown in FIG. 1;

FIG. 3 is a diagram showing an example of recipes stored in a control computer; and

FIG. 4 is a flowchart showing flow of processing performed by the control computer to determine a chemical solution supply temperature.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

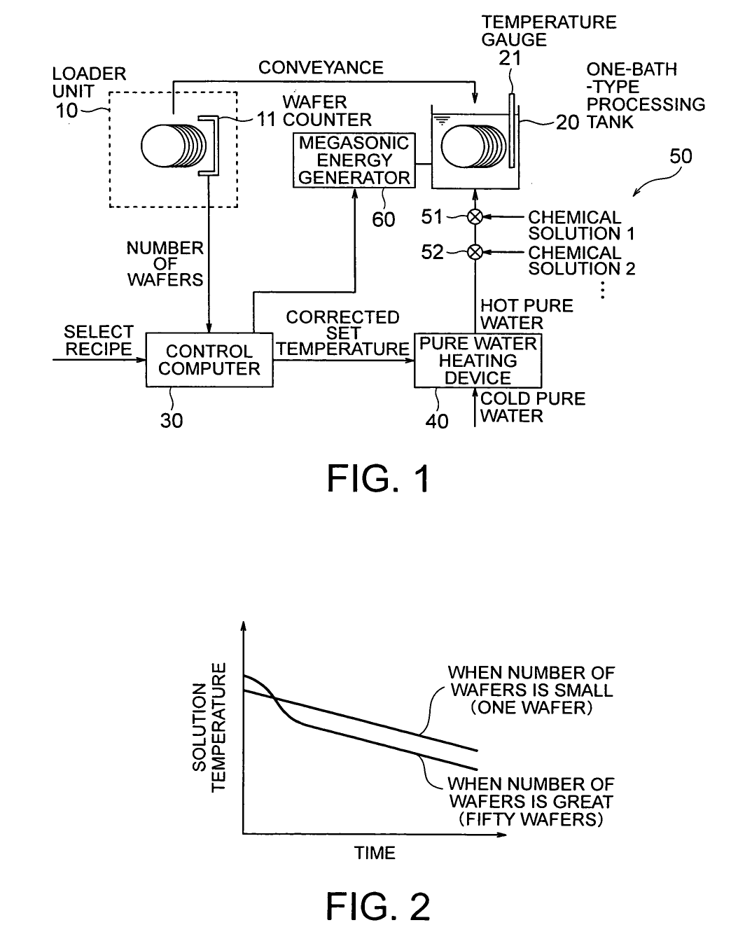

FIG. 1 is a schematic block diagram showing configuration of a batch-type semiconductor substrate cleaning apparatus according to a first embodiment of the present invention. The semiconductor substrate cleaning apparatus includes a loader unit 10 for loading semiconductor substrates as objects to be cleaned into the cleaning apparatus, a one-bath-type cleaning tank (processing tank) 20 designed to clean the substrates while disposing chemical solution after every batch, a control computer 30 for controlling various units of the apparatus, a pure water heating device 40 for heating pure water and supplying the same to the cleaning tank, a piping system 50 for supplying the pure water and a chemical solution, and a conveyor robot (not shown) for conveying the objects to be cleaned from the outside to the inside of the apparatus or vice versa.

The control computer 30 has a communication function to perform communication with an external host computer, and receives from the host computer a command to clean the semiconductor substrates and various information relating to the objects to be cleaned. The control computer 30 is also able to give the host computer information relating to conditions of the various units of apparatus during a cleaning process. The control computer 30 holds “recipes” each of which is formed by a set of conditions for cleaning the objects to be cleaned. In response to an instruction from the host computer or the operator, the control computer 30 selects one of the recipes and issues a command to the units in the apparatus to perform the cleaning processing according to the selected recipe. The control computer 30 need not necessarily be formed by a single unit, but may be formed, for example, by a combination of a computer for individually controlling the respective units of the apparatus and a computer for integrating and controlling the units.

The loader unit 10 is provided with a wafer counter 11 for counting the number of semiconductor substrates as objects to be processed. A counter value counted by the wafer counter 11 is transmitted to the control computer 30. The control computer 30 can compare the counter value received from the wafer counter 11 with a number of objects to be cleaned provided by the host computer. Therefore, the control computer 30 collectively holds information relating to the number of objects to be cleaned and information relating to conditions for cleaning the objects to be cleaned such as solution temperature.

The one-bath-type cleaning tank 20, which is normally filled with pure water, is supplied with a chemical solution before or after the objects to be cleaned are loaded. The objects to be cleaned are conveyed by the conveyor robot from the loader unit 10 to the cleaning tank 20. When a certain period of time has passed after the loading of the objects to be cleaned, pure water is supplied to the cleaning tank 20 to rinse the objects to be cleaned. At the same time, the chemical solution in the cleaning tank 20 is replaced with the pure water and the cleaning tank 20 is filled with the pure water.

A pipe for supplying pure water is connected to the cleaning tank 20, and a pure water heating device 40 for heating pure water to a desired temperature is provided in the pipe line. The pure water heating device 40 has a function to communicate with the control computer 30 of the cleaning apparatus, so that the pure water heating device 40 heats the pure water up to a desired temperature according to a command from the control computer 30. The pure water supply pipe is further provided with one or a plurality of mixing valves 51, 52 downstream the pure water heating device 40, and chemical solution supply pipes are connected to the mixing valves 51, 52, respectively. When one of the mixing valves 51, 52 is opened, a chemical solution is supplied into the pure water supply pipe at a predetermined flow rate according to a command from the control computer 30 of the cleaning apparatus, and thus the chemical solution diluted with the pure water is supplied to the cleaning tank 20.

The plurality of mixing valves 51, 52 can be opened at the same time to mix several different types of chemical solutions together. Further, a temperature gauge 21 is provided, inside the one-bath-type cleaning tank 20, for measuring a temperature of the chemical solution in the tank. A measurement value obtained by the temperature gauge 21 is delivered to the control computer 30. If necessary, the measurement value is further delivered from the control computer 30 to an external host computer.

The cleaning tank 20 is provided with a function to apply megasonic waves for removing contaminants from the substrate surface. The megasonic energy is generated by a megasonic energy oscillator 60 formed by a piezoelectric transducer. The oscillator 60 is activated in response to a command from the control computer 30. Since the cleaning tank 20 is not provided with a temperature control function, if no measure is taken, the temperature of the chemical solution will vary due to cooling effect of natural heat dissipation, change in temperature caused by loading of substrates, supply of thermal energy from the megasonic waves or the like.

For example, when a chemical solution is supplied at 25° C. near room temperature, and megasonic waves are applied at an output of 300 W from the bottom of the cleaning tank 20, the solution temperature increases by 0.5 to several degrees Celsius in ten minutes depending on the material and capacity of the cleaning tank 20, the flow rate of exhaust air, and so on. When the chemical solution is supplied at a high temperature of 85° C. after once emptying the cleaning tank 20, and then the objects to be cleaned are loaded in the tank, the solution temperature drops. For example, as shown in FIG. 2, when a single silicon wafer having a diameter of 300 mm is loaded, the drop in solution temperature at the time of the loading is very small, whereas when fifty wafers are loaded, the solution temperature drops by about 1.5 to 2° C. in about 30 second after the loading.

The variation in solution temperature described above indicates high reproducibility if the solution temperature at the time of the supply of the chemical solution, the number of semiconductor substrates, and the intensity of the applied megasonic waves are fixed. The temperature of the pure water containing the chemical solution (hereafter, simply referred to as the chemical solution) at the time of supply thereof is determined by a command given by the control computer 30 to the pure water heating device 40. In the embodiment, therefore, data on time variation in solution temperature is preliminarily obtained by actually measuring the solution temperature while varying the solution temperature at the time of supply of the chemical solution, the number of semiconductor substrates, and the intensity of applied megasonic waves, and the data is held in a database of the control computer 30. The cleaning apparatus is thus enabled to predict variation in solution temperature and average solution temperature during cleaning by supplementing the information given to the control computer 30 and relating to the number of objects to be cleaned and cleaning conditions, with the data held in the database. Accordingly, the predicted values can be used to change the solution temperature at the time of supply of the chemical solution, whereby the solution temperature can be kept constant during cleaning regardless of the number of wafers or cleaning conditions. The average solution temperature can also be kept constant among different batches.

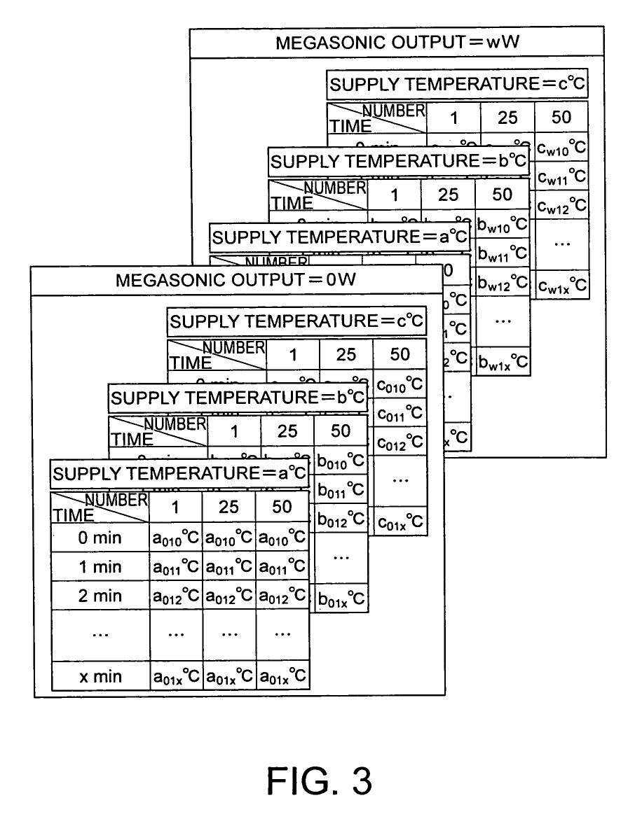

FIG. 3 shows an example of contents of recipes in the database held by the control computer 30. Operation of a batch-type cleaning apparatus according to the embodiment will be described with reference to FIGS. 1 and 3. In the cleaning apparatus, the cleaning tank 20 is a one-bath-type cleaning tank designed to dispose chemical solution after every batch. Firstly, one or a plurality of semiconductor wafers as objects to be cleaned are loaded in the loader unit 10 of the cleaning apparatus. Substantially simultaneously with this, one of the “recipes” consisting of sets of conditions for cleaning the objects to be cleaned and held by the control computer 30 is selected by communication from the external host computer or manually by the operator.

Each of the recipes contains information relating to the supply temperature of a chemical solution supplied to the one-bath-type cleaning tank 20, the concentration of the chemical solution, the cleaning time, the number of wafers, the output of megasonic waves applied for removing contaminants during cleaning, the procedure of water washing after the cleaning, and the like. When selecting one of the recipes, the number of objects to be cleaned is input to the control computer 30 at the same time. The loaded semiconductor wafers are counted by the wafer counter 11 provided in the loader unit 10. The counted value is compared with the number of objects to be cleaned that has been preliminarily input to the control computer 30 to check whether the two values match with each other.

As shown in FIG. 3, the control computer 30 holds in its database recipes of data on time variation in temperature of the chemical solution temperature in association with various combinations of temperature of the chemical solution supplied to the one-bath-type cleaning tank 20, number of objects to be cleaned, and output of the megasonic waves. This database is generated when fabricating the cleaning apparatus or based on data obtained by actual measurement when starting up the apparatus.

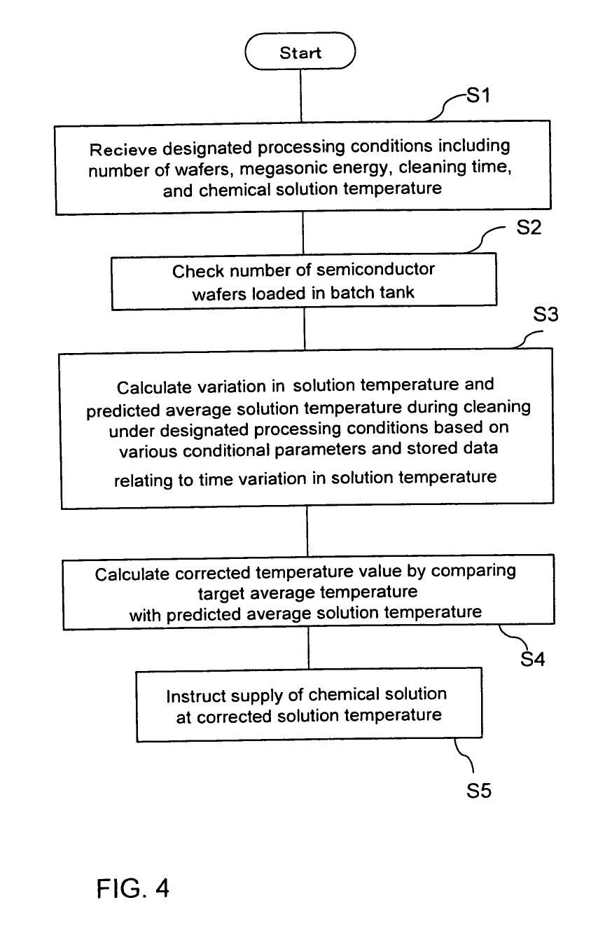

Learning the number of the objects to be cleaned, the control computer 30 calculates a target temperature using a specific formula based on the supply temperature of the chemical solution supplied to the one-bath-type cleaning tank described in the selected recipe, such that the target temperature is lower than the supply temperature. The formula used herein may be, for example, a formula to simply subtract a constant from the supply temperature. The control computer 30 then predicts an average solution temperature during the cleaning time by supplementing, with the data in the database, the supply temperature of the chemical solution supplied to the one-bath-type cleaning tank, the cleaning time, the output of megasonic waves, and the counted value of the objects to be cleaned described in the recipe. The control computer 30 then compares the predicted average solution temperature with the target temperature and corrects the chemical solution supply temperature based on a specific formula. For example, this correction may be implemented by adding a difference between the target temperature and the average solution temperature to the chemical solution supply temperature described in the recipe. FIG. 4 is a flowchart showing the steps performed by the control computer to determine a corrected chemical solution supply temperature.

The chemical solution supply temperature newly calculated by the control computer 30 is delivered to the pure water heating device 40 for supplying heated pure water to the one-bath-type cleaning tank 20. The pure water heating device 40 heats pure water up to the new chemical solution supply temperature informed by the control computer 30 and starts supply of the heated pure water. The mixing valves 51, 52 connected to the outgoing pipes from the pure water heating device 40 are selectively turned open according to an instruction based on the recipe, whereby chemical solution is mixed with the heated pure water supplied from the pure water heating device 40 and the mixed chemical solution having a predetermined mixture ratio is supplied to the one-bath-type cleaning tank 20.

The one-bath-type cleaning tank 20 in a standby state is normally filled with pure water. After removing the pure water from the tank, the chemical solution diluted with the pure water is supplied into the tank. The chemical solution is supplied according to the selected recipe before or after the objects to be cleaned are conveyed from the loader unit 10 to the one-bath-type cleaning tank 20.

In the embodiment, the average solution temperature in the cleaning time can be kept substantially constant by correcting the supply temperature of the chemical solution according to the number of objects to be cleaned, the cleaning time, and the output (W) of megasonic waves. As a result, the cleaning effect obtained by the cleaning process and the etching amount obtained by etching various types of thin films can be kept uniform regardless of the number of objects to be processed or the processing time. Further, the chemical solution supply temperature can be controlled according to predetermined profile in order to keep the average solution temperature at a fixed level. Alternatively, the design may be such that a predetermined solution temperature profile can be obtained during cleaning.

The control computer 30 may be provided with a learning function as a modification of the embodiment described above.

The one-bath-type cleaning tank 20 is provided with a temperature gauge 21 for measuring the temperature of chemical solution in the tank, and data obtained by actual measurement of the solution temperature is delivered to the control computer 30. The control computer 30 is thus enabled to record the time variation in the solution temperature during cleaning and to compute an actual average solution temperature based on the information thus recorded. A difference between the actual average temperature and the average temperature predicted before the cleaning is used as error information.

When another cleaning process occurs in the future in which all the conditions of number of objects to be cleaned, chemical solution supply temperature, cleaning time, and output of megasonic waves match, a predicted average solution temperature is corrected based on the error information. This makes it possible to improve the precision of the predicted value. For example, the correction is performed by adding the difference between the actual average temperature and the predicted average temperature to a subsequently predicted solution temperature. Alternatively, error information obtained by a plurality of cleaning processes conducted under the same conditions may be stored so that a predicted solution temperature is corrected by using an average value of the stored error information. In this case, the precision of the predicted value can be improved further.

The precision of predicting the solution temperature can be improved by supplementing the database by adding data of time variation in actually measured solution temperature thereto. In this case, again, the precision can be improved by accumulating data obtained by performing a plurality of cleaning processes under the same conditions and averaging the stored data. This modified embodiment is able to achieve even higher precision in temperature correction than the embodiment described above.

According to the embodiments of the present invention, the control computer 30 preliminarily stores, in its database, time variation in chemical solution temperature observed when varying parameters including chemical solution supply temperature, number of semiconductor wafers as objects to be cleaned, and intensity of applied megasonic waves, for each combination of the parameters. When wafers are actually loaded, the number of loaded wafers is counted by the wafer counter 11 arranged in the loader unit 10. The control computer 30 supplements the data in the database with respect to the counted number of wafers and the processing conditions such as chemical solution supply temperature, intensity of applied megasonic waves, and processing time. The control computer 30 thus predicts time variation in chemical solution temperature and an average solution temperature during the processing time. By changing the chemical solution supply temperature according to the predicted value of average solution temperature, it is made possible to perform a cleaning process while keeping the average solution temperature at a fixed level regardless of the number of wafers or change in processing conditions.

Although this invention has been described in conjunction with preferred embodiments thereof, it will be appreciated by those skilled in the art that those embodiments are provided for illustrating the invention, and should not be relied upon to construe the appended claims in a limiting sense.

What is claimed is:

1. A batch processing apparatus for performing batch processing by immersing objects to be processed in a process solution, comprising:
a batch tank;
a supply unit supplying the process solution to the batch tank;
a supersonic waves generating source applying supersonic waves to the objects to be processed in the batch tank; and
a control unit controlling supply temperature of the process solution based on data representing at least relationship between output of applied supersonic waves and variation in temperature of the process solution.

2. A batch processing apparatus claimed in claim 1, further comprising:
a data storage unit storing the data at least representing the relationship between the output of applied supersonic waves and the variation in temperature of the process solution; and wherein:
the control unit, in response to designated processing conditions, determines the supply temperature of the process solution based on the stored data in the data storage unit.

3. A batch processing apparatus as claimed in claim 2, wherein the control unit predicts variation in temperature of the process solution in the batch tank caused at least by application of supersonic waves to the process solution based on the stored data, and determines the supply temperature to compensate the predicted variation in the temperature of the process solution.

4. A batch processing apparatus as claimed in claim 3, wherein the control unit determines the supply temperature such that an average solution temperature of the process solution in the batch tank in process time is uniform among different batches.

5. A batch processing apparatus as claimed in claim 2, wherein the data includes data associating the number of objects to be batch-processed, the output of supersonic waves, and the variation in average solution temperature predicted for the process solution in the batch tank.

6. A batch processing apparatus as claimed in claim 1, wherein the objects to be batch-processed comprise semiconductor wafers.

7. A batch processing apparatus as claimed in claim 6, wherein the batch tank comprises a one-bath-type cleaning tank, and the batch processing apparatus comprises a cleaning apparatus cleaning semiconductor wafers.

8. A batch processing apparatus as claimed in claim 1, further comprising a counting unit counting a number of the semiconductor work pieces.

9. A batch processing apparatus for processing semiconductor work pieces by applying supersonic waves to the semiconductor work pieces in a process solution in a batch tank, comprising:
a supply unit supplying the process solution to the batch tank;
a data storage unit storing data relating to time variation in process solution temperature based on actually measured temperature values for each set of parameters including at least process solution supply temperature, number of semiconductor work pieces, and intensity of applied supersonic waves; and
a control unit which, in response to designation of processing conditions including number of semiconductor work pieces, intensity of applied supersonic waves, temperature of a supplied chemical solution, and processing time, predicts an average solution temperature during processing under the designated conditions by supplementing the designated processing conditions with the data stored in the data storage unit, determines a supply temperature of the process solution based on the predicted average solution temperature, and controls the supply unit.

10. A solution temperature control method in a batch processing apparatus for processing semiconductor work pieces by applying supersonic waves to the semiconductor work pieces in a process solution in a batch tank, comprising:
storing data relating to time variation in process solution temperature based on actually measured temperature values for each set of parameters including at least process solution supply temperature, number of semiconductor work pieces, and intensity of applied supersonic waves;
counting a number of the semiconductor work pieces;
designating processing conditions including number of semiconductor work pieces, intensity of applied supersonic waves, temperature of supplied chemical solution, and processing time;
predicting an average solution temperature during processing under the designated processing conditions by supplementing the designated processing conditions with the stored data, thereby providing a supply temperature of the process solution based on the predicted average solution temperature; and
supplying the process solution at the supply temperature to the batch tank.

11. The solution temperature control method in a batch processing apparatus as claimed in claim 10, further comprising calculating a target temperature that is lower than the temperature of process solution designated as one of the processing conditions, wherein the supply temperature of process solution is determined based on the target temperature and the predicted average solution temperature.

12. A solution temperature control method in a batch processing apparatus as claimed in claim 10, wherein the supply temperature of a process solution supplied to the batch tank is controlled such that an average temperature of the process solution in the batch tank during the processing time is uniform among different batches.

13. A solution temperature control method in a batch processing apparatus as claimed in claim 10, wherein the batch tank comprises a one-bath-type cleaning tank, and the batch processing apparatus comprises a cleaning apparatus cleaning semiconductor wafers.
